(19) United States
(12) Patent Application Publication
(10) Pub. No.: US 2025/0269795 A1
(43) Pub. Date: Aug. 28, 2025

(54) VEHICULAR VIEWING DEVICE AND METHOD OF ASSEMBLING VEHICULAR VIEWING DEVICE

(71) Applicant: KABUSHIKI KAISHA TOKAI-RIKA-DENKI-SEISAKUSHO, Niwa-gun (JP)

(72) Inventors: Nami MASUTANI, Aichi (JP); Yuto NAKAYAMA, Aichi (JP)

(21) Appl. No.: 19/061,314

(22) Filed: Feb. 24, 2025

(30) Foreign Application Priority Data
Feb. 27, 2024 (JP) 2024-027811

(51) Int. Cl. B60R 1/076

(52) U.S. Cl. CPC B60R 1/076

(57) ABSTRACT

In a door mirror device, a base is attached to a vehicle body side, and the base supports a mirror and is covered by an inner cover. Here, the inner cover is rotated in a state in which an insertion tube of the base is inserted into an insertion hole in the inner cover, whereby the inner cover is locked in the axial direction and the circumferential direction of the insertion hole to the base. For this reason, the inner cover can be stably rotated, and the inner cover can be easily assembled to the base.

### CROSS-REFERENCE TO RELATED APPLICATION

This application is based on and claims priority under 35 USC 119 from Japanese Patent Application No. 2024-27811 filed on Feb. 27, 2024, the disclosure of which is incorporated by reference herein.

### BACKGROUND

### Technical Field

The present invention relates to a vehicular viewing device where a cover body covers a support body that supports a viewing mechanism and to a method of assembling the vehicular viewing device.

### Related Art

Japanese Utility Model Application Laid-open (JP-U) No. S63-6953 discloses a door mirror structure where a core portion is attached to a vehicle body side, and the core portion supports a mirror and is covered by a cover portion.

Here, in this door mirror structure, a plate-shaped part of the core portion is inserted into a holding portion of the cover portion while the cover portion is rotated, and a projection on the plate-shaped part is mated with a recess in the holding portion, whereby the cover portion is locked in the holding portion axial direction and the holding portion circumferential direction to the core portion.

### SUMMARY

In consideration of the circumstances described above, it is an object of the present invention to obtain a vehicular viewing device with which a cover body can be easily assembled to a support body and a method of assembling the vehicular viewing device.

A vehicular viewing device of a first aspect of the invention includes: a viewing mechanism that assists viewing by an occupant; a support body that is attached to a vehicle body side and that supports the viewing mechanism; and a cover body that is provided with an insertion hole, that is rotated in an insertion hole circumferential direction in a state in which the support body is inserted into the insertion hole whereby the cover body is locked in an insertion hole axial direction and the insertion hole circumferential direction to the support body, and that covers the support body.

In the vehicular viewing device of the first aspect of the invention, the viewing mechanism assists viewing by the occupant. Furthermore, the support body is attached to the vehicle body side, and the support body supports the viewing mechanism and is covered by the cover body.

Here, the cover body is rotated in the insertion hole circumferential direction in a state in which the support body is inserted into the insertion hole in the cover body, whereby the cover body is locked in the insertion hole axial direction and the insertion hole circumferential direction to the support body. For this reason, the cover body can be stably rotated, and the cover body can be easily assembled to the support body.

A vehicular viewing device of a second aspect of the invention is the vehicular viewing device of the first aspect of the invention, further including a raised portion that is provided at one of the support body or the cover body, and a recessed portion that is provided at another of the support body or the cover body and into which the raised portion is inserted whereby the cover body is locked in the insertion hole axial direction and the insertion hole circumferential direction to the support body.

In the vehicular viewing device of the second aspect of the invention, the raised portion on one of the support body or the cover body is inserted into the recessed portion in the other of the support body or the cover body, whereby the cover body is locked in the insertion hole axial direction and the insertion hole circumferential direction to the support body. For this reason, the cover body can be easily locked in the insertion hole axial direction and the insertion hole circumferential direction to the support body.

A vehicular viewing device of a third aspect of the invention is the vehicular viewing device of the second aspect of the invention, wherein the raised portion is inserted into the recessed portion whereby the cover body is locked in an insertion hole radial direction to the support body.

In the vehicular viewing device of the third aspect of the invention, the raised portion is inserted into the recessed portion, whereby the cover body is locked in the insertion hole radial direction to the support body. For this reason, the cover body can be locked in the insertion hole radial direction to the support body with a simple configuration.

A vehicular viewing device of a fourth aspect of the invention is the vehicular viewing device of any of the first aspect to the third aspect of the invention, further including an engagement portion that is provided at the cover body and that is engaged with the support body whereby rotation of the cover body in a direction in which the locking of the cover body in the insertion hole axial direction and the insertion hole circumferential direction to the support body is canceled, is locked.

In the vehicular viewing device of the fourth aspect of the invention, the engagement portion of the cover body is engaged with the support body, whereby rotation of the cover body in a direction in which the locking of the cover body in the insertion hole axial direction and the insertion hole circumferential direction to the support body is canceled, is locked. For this reason, the locking of the cover body in the insertion hole axial direction and the insertion hole circumferential direction to the support body can be limited from being canceled.

A vehicular viewing device of a fifth aspect of the invention is the vehicular viewing device of any of the first aspect to the fourth aspect of the invention, wherein the support body supports the cover body in the insertion hole axial direction and guides the rotation of the cover body in the insertion hole circumferential direction.

In the vehicular viewing device of the fifth aspect of the invention, the support body supports the cover body in the insertion hole axial direction and guides the rotation of the cover body in the insertion hole circumferential direction. For this reason, the cover body can be even more stably rotated in the insertion hole circumferential direction.

A method of assembling a vehicular viewing device of a sixth aspect of the invention is a method of assembling a vehicular viewing device including a viewing mechanism that assists viewing by an occupant, a support body that is attached to a vehicle body side and that supports the viewing mechanism, and a cover body that is provided with an insertion hole and that covers the support body, wherein the cover body is rotated in an insertion hole circumferential direction in a state in which the support body is inserted into the insertion hole whereby the cover body is locked in an insertion hole axial direction and the insertion hole circumferential direction to the support body.

In the vehicular viewing device at the sixth aspect of the invention, the viewing mechanism assists viewing by the occupant. Furthermore, the support body is attached to the vehicle body side, and the support body supports the viewing mechanism and is covered by the cover body.

Here, in the method of assembling the vehicular viewing device of the sixth aspect of the invention, the cover body is rotated in the insertion hole circumferential direction in a state in which the support body is inserted into the insertion hole in the cover body, whereby the cover body is locked in the insertion hole axial direction and the insertion hole circumferential direction to the support body. For this reason, the cover body can be stably rotated, and the cover body can be easily assembled to the support body.

### BRIEF DESCRIPTION OF THE DRAWINGS

An exemplary embodiment of the present invention will be described in detail based on the following figures, wherein:

FIG. 1A is a back view showing a door mirror device pertaining to the embodiment of the invention as viewed from the front side of a vehicle;

FIG. 1B is a perspective view showing the door mirror device pertaining to the embodiment of the invention as viewed from the rear side of the vehicle and inward in the vehicle width direction;

FIG. 2A is a perspective view showing main portions of the door mirror device pertaining to the embodiment of the invention as viewed from the rear side of the vehicle and outward in the vehicle width direction;

FIG. 2B is a perspective view showing main portions of the door mirror device pertaining to the embodiment of the invention as viewed from the front side of the vehicle and outward in the vehicle width direction;

FIG. 3A is a side view showing a base of the door mirror device pertaining to the embodiment of the invention as viewed from outward in the vehicle width direction;

FIG. 3B is a side view showing the base of the door mirror device pertaining to the embodiment of the invention as viewed from inward in the vehicle width direction;

FIG. 4A is a front elevation view showing the base of the door mirror device pertaining to the embodiment of the invention as viewed from the front side of the vehicle;

FIG. 4B is a top view showing the base of the door mirror device pertaining to the embodiment of the invention as viewed from above;

FIG. 5A is a perspective view showing an inner cover of the door mirror device pertaining to the embodiment of the invention as viewed from the rear side of the vehicle and inward in the vehicle width direction;

FIG. 5B is a perspective view showing the inner cover of the door mirror device pertaining to the embodiment of the invention as viewed from the front side of the vehicle and outward in the vehicle width direction;

FIG. 6A is a perspective view showing the inner cover of the door mirror device pertaining to the embodiment of the invention as viewed from the rear side of the vehicle and outward in the vehicle width direction;

FIG. 6B is a perspective view showing the inner cover of the door mirror device pertaining to the embodiment of the invention as viewed from below;

FIG. 7A is a top view showing the inner cover being assembled to the base in the door mirror device pertaining to the embodiment of the invention as viewed from above; and

FIG. 7B is a cross-sectional view (a cross-sectional view taken along line 7B-7B of FIG. 7A) showing the inner cover being assembled to the base in the door mirror device pertaining to the embodiment of the invention as viewed from the front side of the vehicle.

### DETAILED DESCRIPTION

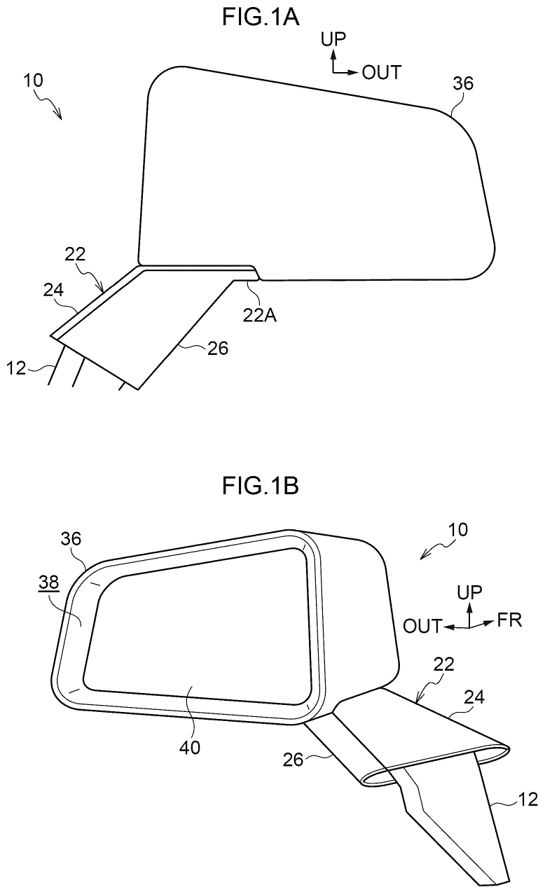

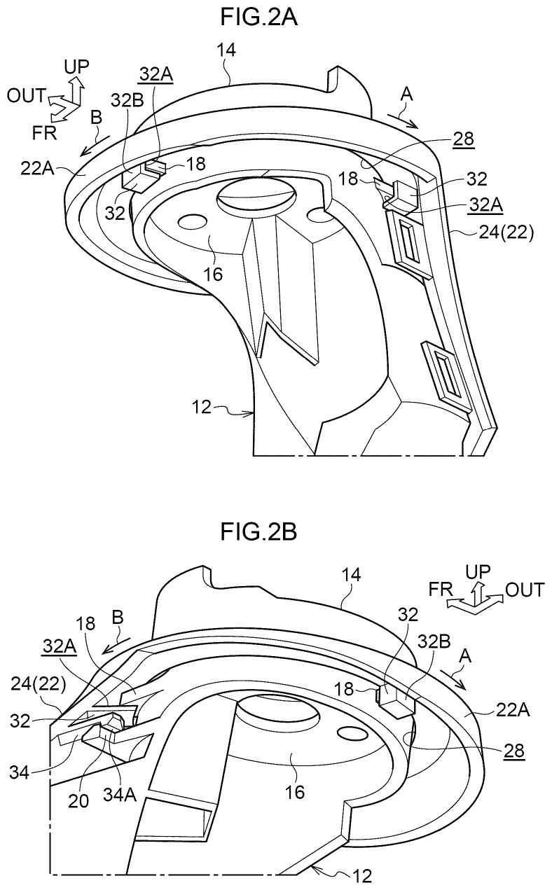

In FIG. 1A, a door mirror device 10 serving as a vehicular viewing device pertaining to an embodiment of the invention is shown in a back view as viewed from the front side of a vehicle, and in FIG. 1B, the door mirror device 10 is shown in a perspective view as viewed from the rear side of the vehicle and inward in the vehicle width direction. Moreover, in FIG. 2A, main portions of the door mirror device 10 are shown in a perspective view as viewed from the rear side of the vehicle and outward in the vehicle width direction, and in FIG. 2B, main portions of the door mirror device 10 are shown in a perspective view as viewed from the front side of the vehicle and outward in the vehicle width direction. It will be noted that in the drawings arrow FR indicates the vehicle forward direction, arrow OUT indicates the outward direction (vehicle leftward direction) in the vehicle width direction, and arrow UP indicates the upward direction.

The door mirror device 10 pertaining to the present embodiment is installed on the vehicle front end portion of the up and down direction middle portion of a side door (front side door; not shown in the drawings) serving as a vehicle body side of a vehicle (automobile) and is disposed on the vehicle outer side of the side door.

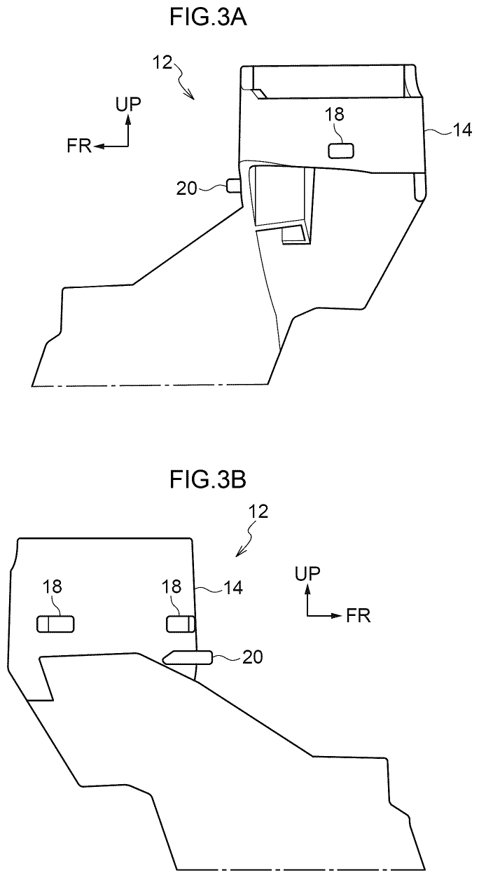

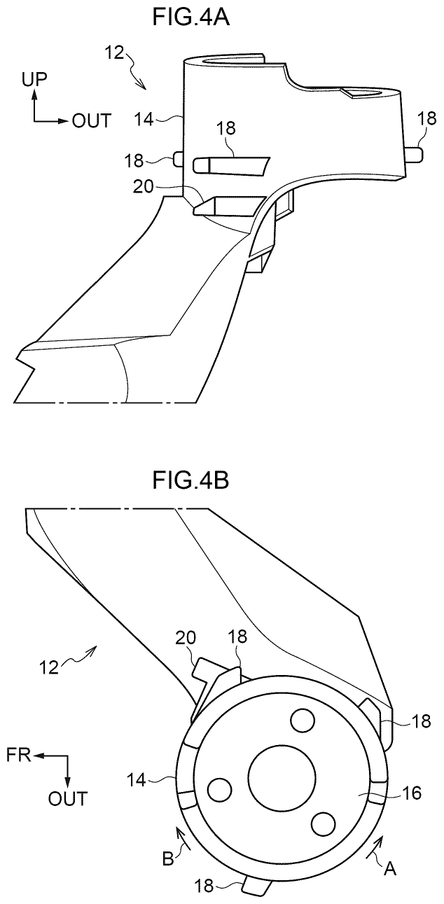

As shown in FIG. 1A, FIG. 1B, FIG. 2A, and FIG. 2B, the door mirror device 10 is provided with a substantially columnar base 12 (see FIG. 3A, FIG. 3B, FIG. 4A, and FIG. 4B) serving as a support body, and the lower portion of the base 12 runs through an outer panel of the side door and is attached to an inner panel of the side door, whereby the door mirror device 10 is installed on the side door.

The upper portion of the base 12 is provided with a substantially round tube-shaped insertion tube 14. The insertion tube 14 projects outward in the vehicle width direction, and its axial direction is substantially aligned with the up and down direction. On the lower portion of the inside of the insertion tube 14, a substantially annular plate-shaped anchor plate 16 is integrally provided, and the anchor plate 16 is disposed coaxially with the insertion tube 14. On the lower portion of the outer periphery of the insertion tube 14, a predetermined number (in the present embodiment, three) of substantially rectangular plate-shaped raised portions 18 are integrally provided, and the predetermined number of raised portions 18 are arranged substantially equidistantly in the circumferential direction of the insertion tube 14. The raised portions 18 are disposed orthogonally to the axial direction of the insertion tube 14, and the positions of the predetermined number of raised portions 18 in the axial direction of the insertion tube 14 coincide with each other. On the lower end portion of the outer periphery of the insertion tube 14, a substantially rectangular plate-shaped engagement plate 20 serving as an engaged portion is integrally provided, and the engagement plate 20 is disposed orthogonally to the axial direction of the insertion tube 14.

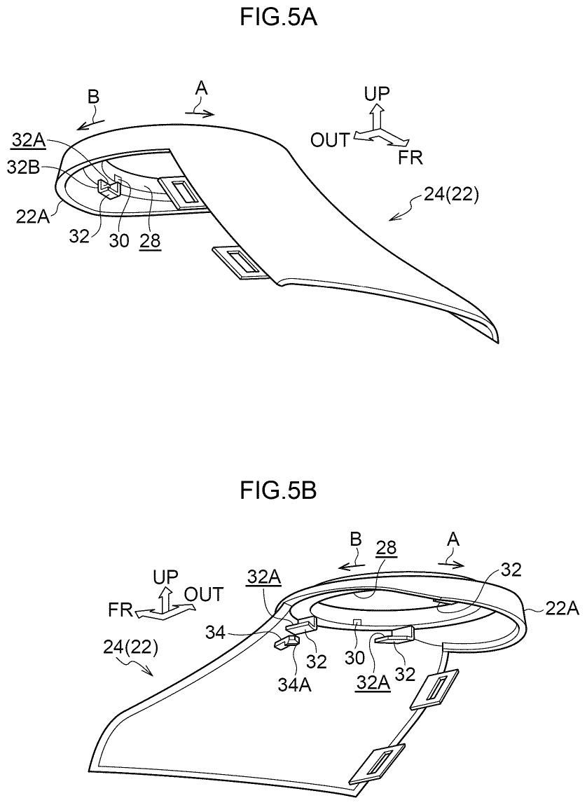

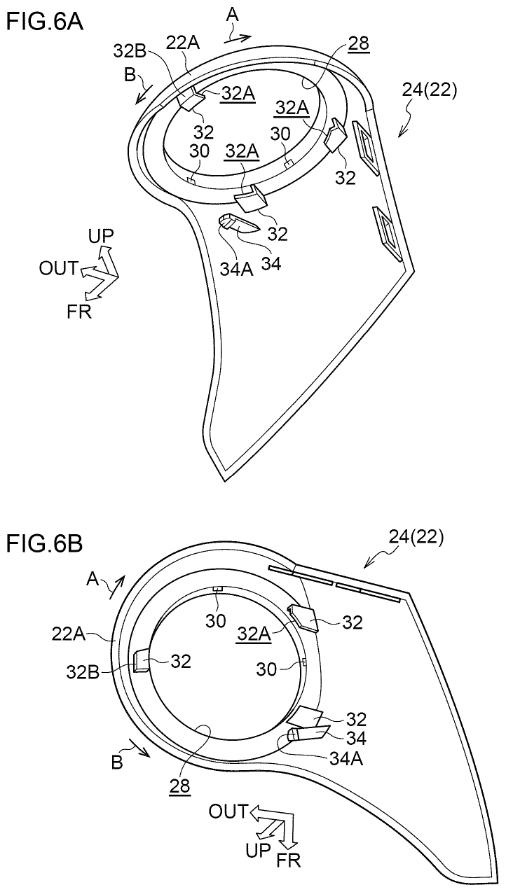

The base 12 is covered, on the upper side of the outer panel of the side door, by a substantially round tube-shaped base cover 22 that is made of resin and serves as a cover member, and the upper end portion of the base cover 22 is configured by a projecting portion 22A and projects outward in the vehicle width direction. The base cover 22 is configured by assembling to each other an inner cover 24 serving as a cover body located on the vehicle width direction inner side (see FIG. 5A, FIG. 5B, FIG. 6A, and FIG. 6B) and an outer cover 26 located on the vehicle width direction outer side. The inner cover 24 configures the upper part (including the vehicle width direction inner part) of the projecting portion 22A, and the outer cover 26 configures the lower part (excluding the vehicle width direction inner part) of the projecting portion 22A.

On the inner cover 24 (the base cover 22), a substantially annular plate-shaped upper wall is integrally provided. The upper wall of the inner cover 24 is disposed substantially orthogonally to the up and down direction, and its lower surface is configured to be planar. The inner peripheral edge of the upper wall of the inner cover 24 is configured substantially in the shape of a round tube and projects upward, and the inside of the upper wall of the inner cover 24 is configured as an insertion hole 28. On the lower portion of the peripheral surface of the insertion hole 28, a predetermined number (in the present embodiment, four) of rectangular planar locking surfaces 30 serving as locking portions are formed. The predetermined number of locking surfaces 30 are arranged equidistantly in the circumferential direction of the insertion hole 28 and are disposed orthogonally to the radial direction of the insertion hole 28. The insertion tube 14 of the base 12 is coaxially inserted into the insertion hole 28 from below, and the locking surfaces 30 are abutted against the insertion tube 14. For this reason, the peripheral surface of the insertion hole 28 is locked to the insertion tube 14 in the radial direction, and the inner cover 24 is locked in the radial direction of the insertion hole 28 to the base 12.

On the lower surface of the upper wall of the inner cover 24, a predetermined number (in the present embodiment, three) of cross-sectionally L-shaped plate-shaped locking pieces 32 are integrally provided, and the predetermined number of locking pieces 32 are arranged substantially equidistantly in the circumferential direction of the insertion hole 28. The insides of the locking pieces 32 are configured as recessed portions 32A and are open in the direction of arrow A (one side in the circumferential direction of the insertion hole 28) and on their insertion hole 28 sides. The sides opposite from the insertion hole 28 of the insides of the locking pieces 32 located on the vehicle width direction inner side are closed off by the peripheral wall of the inner cover 24, and the side opposite from the insertion hole 28 of the inside of the locking piece 32 located on the vehicle width direction outer side is closed off by a closure wall 32B.

The raised portions 18 of the base 12 (the insertion tube 14) are inserted into the locking pieces 32 (the recessed portions 32A). The proximal end walls (upper walls) of the locking pieces 32 are abutted against the raised portions 18, whereby rotation of the locking pieces 32 in the direction of arrow A is locked by the raised portions 18, and the inner cover 24 is locked in the direction of arrow A to the base 12. The distal end walls (lower walls) of the locking pieces 32 and the upper wall of the inside cover 24 are abutted against the raised portions 18, whereby the locking pieces 32 are locked to the raised portions 18 on both sides in the up and down direction, and the inner cover 24 is locked on both sides in the up and down direction to the base 12.

On the upper portion of the inner surface of the peripheral wall of the inner cover 24, an engagement claw 34 serving as an engagement portion is integrally provided, and the engagement claw 34 extends on the side of the direction of arrow A on the lower side of the locking pieces 32. On the distal end portion of the engagement claw 34, a claw portion 34A that is substantially trapezoidal in cross-section is integrally provided, and the claw portion 34A projects downward. The claw portion 34A is engaged with the engagement plate 20 of the base 12 (the insertion tube 14) from above, whereby rotation of the engagement claw 34 in the direction of arrow B (the other side in the circumferential direction of the insertion hole 28) is locked by the engagement plate 20, and the inner cover 24 is locked in the direction of arrow B to the base 12.

On the upper side of the base 12 is disposed a storage mechanism (not shown in the drawings) serving as a support mechanism. The lower portion of the storage mechanism is inserted into the insertion tube 14 of the base 12 from above. When, in a state in which a predetermined number (in the present embodiment, three) of screws (not shown in the drawings) have been passed through the anchor plate 16 inside the insertion tube 14 from below, the lower portion of the storage mechanism is fastened by the screws to the anchor plate 16, the storage mechanism (not shown in the drawings) is anchored to and supported by the upper side of the base 12.

The upper part of the storage mechanism above the lower portion is inserted into the vehicle width direction inner portion of a substantially cuboidal box-shaped visor 36 serving as a surrounding body, and the visor 36 is anchored to and supported by the storage mechanism. The vehicle rear surface of the visor 36 is configured as a substantially rectangular opening 38, and the opening 38 opens the inside of the visor 36 in the vehicle rearward direction.

Inside the visor 36, a substantially rectangular plate-shaped mirror 40 serving as a viewing mechanism is supported, and the mirror 40 is disposed in the opening 38 of the visor 36. The obverse side of the mirror 40 is exposed in the vehicle rearward direction through the opening 38 of the visor 36, and viewing in the vehicle rearward direction by an occupant of the vehicle is assisted by the occupant viewing light reflected by the mirror 40.

It will be noted that when the storage mechanism is activated in one direction, the visor 36 and the mirror 40 are pivoted in the vehicle rearward direction and inward in the vehicle width direction about the insertion tube 14 and stored. Moreover, when the storage mechanism is activated in the other direction, the visor 36 and the mirror 40 are pivoted in the vehicle forward direction and outward in the vehicle width direction about the insertion tube 14 and erected (restored).

Next, the action of the present embodiment will be described.

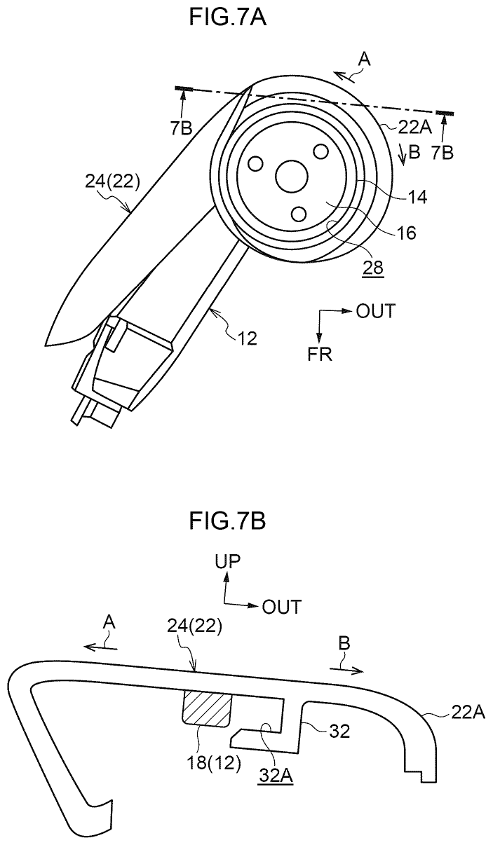

When assembling the door mirror device 10 having the above configuration, in a state in which the insertion tube 14 of the base 12 has been inserted into the insertion hole 28 of the inner cover 24 of the base cover 22 from below, the inner cover 24 is rotated in the direction of arrow A and the raised portions 18 of the base 12 are inserted into the locking pieces 32 (the recessed portions 32A) of the inner cover 24 (see FIG. 7A and FIG. 7B). Moreover, the engagement claw 34 of the inner cover 24 is temporarily elastically deformed upward by the engagement plate 20 of the base 12, and the claw portion 34A of the engagement claw 34 becomes engaged with the engagement plate 20.

Then, the lower portion of the storage mechanism inside the visor 36 is inserted into the insertion tube 14 of the base 12 from above, and the lower portion of the storage mechanism is fastened by the predetermined number of screws to the anchor plate 16 inside the insertion tube 14 from below, whereby the visor 36 (including the storage mechanism and the mirror 40) is supported by the upper side of the base 12.

Thereafter, when the outer cover 26 is assembled to the inner cover 24, the base cover 22 is configured and the part of the base 12 between the side door (the outer panel) and the visor 36 is covered by the base cover 22.

Here, in the state in which the insertion tube 14 of the base 12 is inserted into the insertion hole 28 of the inner cover 24, the inner cover 24 is rotated in the direction of arrow A (the one side in the circumferential direction of the insertion hole 28) and the raised portions 18 of the base 12 are inserted into the locking pieces 32 (the recessed portions 32A) of the inner cover 24, whereby the distal end portions and the proximal end portions of the locking pieces 32 are abutted against the raised portions 18, and the inner cover 24 is locked in the upward direction (one side in the axial direction of the insertion hole 28) and the direction of arrow A to the base 12. For this reason, the inner cover 24 can be stably rotated in the direction of arrow A by the insertion of the insertion tube 14 into the insertion hole 28, and the inner cover 24 can be easily assembled to the base 12. Moreover, in contrast to a case where an elastic claw extending downward from the upper wall of the inner cover 24 is locked to the base 12 and the inner cover 24 is locked to the base 12 in the upward direction, the up and down direction dimension of the projecting portion 22A of the base cover 22 can be limited from becoming larger because of the elastic claw, design freedom for the base cover 22 can be raised, and the strength of the locking of the inner cover 24 to the base 12 in the upward direction can be limited from becoming lower because of the elastic claw.

Moreover, as described above, the raised portions 18 of the base 12 are inserted into the locking pieces 32 of the inner cover 24, and the inner cover 24 is locked in the upward direction and the direction of arrow A to the base 12. For this reason, the inner cover 24 can be easily locked in the upward direction and the direction of arrow A to the base 12.

Moreover, the upper wall of the inner cover 24 is locked in the downward direction (the other side in the axial direction of the insertion hole 28) to the raised portions 18 of the base 12. For this reason, the inner cover 24 can be locked in the downward direction to the base 12.

Furthermore, the insertion tube 14 of the base 12 is inserted into the insertion hole 28 of the inner cover 24, and the locking surfaces 30 on the peripheral surface of the insertion hole 28 are abutted against the insertion tube 14, whereby the peripheral surface of the insertion hole 28 is locked to the insertion tube 14 in the radial direction, and the inner cover 24 is locked in the radial direction of the insertion hole 28 to the base 12. For this reason, the inner cover 24 can be locked in the radial direction of the insertion hole 28 to the base 12.

Moreover, the claw portion 34A of the engagement claw 34 of the inner cover 24 is engaged with the engagement plate 20 of the base 12, whereby rotation of the inner cover 24 in the direction of arrow B (the other side in the circumferential direction of the insertion hole 28, the direction in which the locking of the inner cover 24 in the upward direction and the direction of arrow A to the base 12 is canceled) is locked. For this reason, the locking of the inner cover 24 in the upward direction and the direction of arrow A to the base 12 can be limited from being canceled.

Furthermore, when the inner cover 24 is rotated in the direction of arrow A, the raised portions 18 of the base 12 support the upper wall of the inner cover 24 from below (the other side in the axial direction of the insertion hole 28) and guide the rotation of the inner cover 24 in the direction of arrow A. For this reason, the inner cover 24 can be rotated even more stably in the direction of arrow A.

It will be noted that in the present embodiment the inner cover 24 is locked in the radial direction of the insertion hole 28 to the base 12 as a result of the locking surfaces 30 on the peripheral surface of the insertion hole 28 of the inner cover 24 being abutted against the insertion tube 14 of the base 12. However, the inner cover 24 may also be locked in the radial direction of the insertion hole 28 to the base 12 as a result of the raised portions 18 of the base 12 being inserted into the locking pieces 32 of the inner cover 24 and the closure portions (the peripheral wall of the inner cover 24 or the closure wall 32B) on the sides of the locking pieces 32 opposite from the insertion hole 28 being abutted against the raised portions 18. Because of this, the inner cover 24 can be locked in the radial direction of the insertion hole 28 to the base 12 with a simple configuration that uses the locking pieces 32 and the raised portions 18.

Furthermore, in the present embodiment, the raised portions 18 are provided on the base 12 and the recessed portions 32A are provided in the inner cover 24. However, the recessed portions 32A may be provided in the base 12 and the raised portions 18 may be provided on the inner cover 24.

Moreover, in the present embodiment, three each of the raised portions 18 and the recessed portions 32A are provided. However, one, two, or four or more each of the raised portions 18 and the recessed portions 32A may be provided.

Furthermore, in the present embodiment, the viewing mechanism is configured by the mirror 40. However, the viewing mechanism may also be configured by a camera, and in this case, viewing by the occupant is assisted by images captured by the camera.

What is claimed is:

1. A vehicular viewing device comprising:
a viewing mechanism that assists viewing by an occupant;
a support body that is attached to a vehicle body side and that supports the viewing mechanism; and
a cover body that is provided with an insertion hole, that is rotated in an insertion hole circumferential direction in a state in which the support body is inserted into the insertion hole whereby the cover body is locked in an insertion hole axial direction and the insertion hole circumferential direction to the support body, and that covers the support body.

2. The vehicular viewing device of claim 1, further comprising
a raised portion that is provided at one of the support body or the cover body, and
a recessed portion that is provided at another of the support body or the cover body and into which the raised portion is inserted whereby the cover body is locked in the insertion hole axial direction and the insertion hole circumferential direction to the support body.

3. The vehicular viewing device of claim 2, wherein the raised portion is inserted into the recessed portion whereby the cover body is locked in an insertion hole radial direction to the support body.

4. The vehicular viewing device of claim 1, further comprising a locking surface that is provided at a peripheral surface of the insertion hole and that is abutted against the support body whereby the cover body is locked in an insertion hole radial direction to the support body.

5. The vehicular viewing device of claim 1, wherein a peripheral wall of the cover body is abutted against the support body whereby the cover body is locked in an insertion hole radial direction to the support body.

6. The vehicular viewing device of claim 1, further comprising an engagement portion that is provided at the cover body and that is engaged with the support body whereby rotation of the cover body in a direction in which the locking of the cover body in the insertion hole axial direction and the insertion hole circumferential direction to the support body is canceled, is locked.

7. The vehicular viewing device of claim 6, wherein the engagement portion extends on an insertion hole circumferential direction side.

8. The vehicular viewing device of claim 6, wherein the engagement portion is elastic.

9. The vehicular viewing device of claim 1, wherein the support body supports the cover body in the insertion hole axial direction and guides the rotation of the cover body in the insertion hole circumferential direction.

10. A method of assembling a vehicular viewing device including a viewing mechanism that assists viewing by an occupant, a support body that is attached to a vehicle body side and that supports the viewing mechanism, and a cover body that is provided with an insertion hole and that covers the support body,
wherein the cover body is rotated in an insertion hole circumferential direction in a state in which the support body is inserted into the insertion hole whereby the cover body is locked in an insertion hole axial direction and the insertion hole circumferential direction to the support body.
